(19) United States
(12) Patent Application Publication
(10) Pub. No.: US 2019/0020015 A1
(43) Pub. Date: Jan. 17, 2019

(54) LITHIUM MANGANESE IRON PHOSPHATE-BASED PARTICULATE FOR A CATHODE OF A LITHIUM BATTERY, LITHIUM MANGANESE IRON PHOSPHATE-BASED POWDERY MATERIAL CONTAINING THE SAME, AND METHOD FOR MANUFACTURING THE POWDERY MATERIAL

(71) Applicant: HCM CO., LTD., Taoyuan City (TW)

(72) Inventors: Hsin-Ta Huang, Taoyuan City (TW); Tai-Hung LIN, Taoyuan City (TW); Yi-Hsuan WANG, Taoyuan City (TW); Chih-Tsung Hsu, Taoyuan City (TW)

(21) Appl. No.: 15/685,467

(22) Filed: Aug. 24, 2017

(30) Foreign Application Priority Data
Jul. 14, 2017 (TW) 106123623

(51) Int. Cl. H01M 4/131; H01M 10/052

(52) U.S. Cl. CPC H01M 4/131; H01M 10/052

(57) ABSTRACT

A lithium manganese iron phosphate-based particulate for a cathode of a lithium battery. The lithium manganese iron phosphate-based particulate includes a core portion and a shell portion. The core portion includes a plurality of first lithium manganese iron phosphate-based nanoparticles which are bound together and which have a first mean particle size. The shell portion encloses the core portion and includes a plurality of second lithium manganese iron phosphate-based nanoparticles which are bound together and which have a second mean particle size larger than the first mean particle size of the first lithium manganese iron phosphate-based nanoparticles of the core portion.

### CROSS-REFERENCE TO RELATED APPLICATION

This application claims priority of Taiwanese Application No. 106123623, filed on Jul. 14, 2017.

### FIELD

The disclosure relates to a lithium manganese iron phosphate-based particulate, and more particularly to a lithium manganese iron phosphate-based particulate for a cathode of a lithium battery. The disclosure also relates to a lithium manganese iron phosphate-based powdery material containing a plurality of the lithium manganese iron phosphate-based particulates, and a method for manufacturing the lithium manganese iron phosphate-based powdery material.

### BACKGROUND

A conventional lithium manganese iron phosphate-based powdery material includes a plurality of primary particles having a mean particle size larger than 300 nm and has a relatively low specific surface area. A lithium battery made by using the lithium manganese iron phosphate-based powdery material for forming a cathode thereof has a thermal stability and a charge-discharge cycling stability which meet commercial requirements. However, since the conventional lithium manganese iron phosphate-based powdery material has a relatively low intrinsic conductivity, the energy density and the large current discharge capability of the lithium battery thus made are unsatisfactory.

In order to improve electrochemical properties of the conventional lithium manganese iron phosphate-based powdery material, a lithium manganese iron phosphate-based powdery material which includes a plurality of primary particles having a mean particle size smaller than 100 nm was prepared to enhance the conductivity of the lithium manganese iron phosphate-based powdery material via reduction of an electron conduction distance thereof. Although an electric capacity and a discharge property of a lithium battery thus made may be effectively improved so as to attain a relatively high energy density for the lithium battery, the lithium manganese iron phosphate-based powdery material having such a nano-scaled mean particle size has an increased specific surface area, which may result in an increased reaction area between a cathode and an electrolyte solution in the lithium battery such that the thermal stability and the charge-discharge cycling stability of the lithium battery at an elevated temperature are reduced.

There are other relevant references disclosing particulate cathode material for a lithium battery. Among others, US 2015/0311527 discloses particulate LMFP (lithium manganese iron phosphate) cathode materials having high manganese contents and small amounts of dopant metals. The cathode materials preferably have primary particle sizes of 200 nm or below.

In addition, CN 105702954 discloses a preparation method of a positive electrode material LiMn₁₋ₓFeₓPO₄/C. The method comprises mixing of an A source with a lithium source and a carbon source for reaction to obtain the positive electrode material LiMn₁₋ₓFeₓPO₄/C. The molar stoichiometric ratio of manganese, iron, and phosphorus (Mn:Fe:P) contained in the A source is 0.45-0.85:0.55-0.15:1. The positive electrode materials prepared in Examples 2 and 4 of CN 105702954 have particle sizes of from 100 nm to 120 nm.

Furthermore, U.S. Pat. No. 9,293,766 discloses a lithium nickel cobalt manganese composite oxide cathode material including a plurality of secondary particles. Each secondary particle consists of aggregates of fine primary particles. Each secondary particle includes lithium nickel cobalt manganese composite oxide. The lithium nickel cobalt manganese composite oxide has a structure with different chemical compositions of primary particles from the surface toward core of each of the secondary particles. The primary particle with rich Mn content near the surface and the primary particle with rich Ni content in the core of the secondary particle of the lithium nickel cobalt manganese composite oxide cathode material have provided the advantages of high safety and high capacity.

### SUMMARY

A first object of the disclosure is to provide a lithium manganese iron phosphate-based particulate for a cathode of a lithium battery to overcome the aforesaid shortcomings.

A second object of the disclosure is to provide a lithium manganese iron phosphate-based powdery material for a cathode of a lithium battery which comprises a plurality of the lithium manganese iron phosphate-based particulates.

A third object of the disclosure is to provide a method for manufacturing the lithium manganese iron phosphate-based powdery material.

According to a first aspect of the disclosure, there is provided a lithium manganese iron phosphate-based particulate for a cathode of a lithium battery. The lithium manganese iron phosphate-based particulate includes a core portion and a shell portion. The core portion includes a plurality of first lithium manganese iron phosphate-based nanoparticles which are bound together and which have a first mean particle size. The shell portion encloses the core portion and includes a plurality of second lithium manganese iron phosphate-based nanoparticles which are bound together and which have a second mean particle size larger than the first mean particle size of the first lithium manganese iron phosphate-based nanoparticles of the core portion.

According to a second aspect of the disclosure, there is provided a lithium manganese iron phosphate-based powdery material for a cathode of a lithium battery which includes a plurality of the lithium manganese iron phosphate-based particulates.

According to a third aspect of the disclosure, there is provided a method for manufacturing the lithium manganese iron phosphate-based powdery material, comprising:

a) preparing a blend which includes a lithium source, a manganese source, an iron source, and a phosphorous source;

b) subjecting the blend to milling and pelletizing to form a pelletized mixture;

c) subjecting the pelletized mixture to a preliminary sintering treatment at a temperature ranging from 300° C. to 450° C. to form a pre-sintered preform;

d) subjecting the pre-sintered preform to an intermediate sintering treatment at a temperature ranging from 450° C. to 600° C. form a mid-sintered preform; and

e) subjecting the mid-sintered preform to a final sintering treatment at a temperature ranging from 600° C. to 800° C. to form the lithium manganese iron phosphate-based powdery material.

### BRIEF DESCRIPTION OF THE DRAWINGS

Other features and advantages of the disclosure will become apparent in the following detailed description of the embodiment (s) with reference to the accompanying drawings, of which:

FIG. 1 is a scanning electron microscope (SEM) image of a lithium manganese iron phosphate-based particulate prepared in Example 1 according to the disclosure;

FIG. 2 is an enlarged SEM image of the lithium manganese iron phosphate-based particulate prepared in Example 1 according to the disclosure;

FIG. 3 is a SEM image of a lithium manganese iron phosphate-based particulate prepared in Comparative Example 1;

FIG. 4 is an enlarged SEM image of the lithium manganese iron phosphate-based particulate prepared in Comparative Example 1;

FIG. 5 is a SEM image of a lithium manganese iron phosphate-based particulate prepared in Comparative Example 2;

FIG. 6 is an enlarged SEM image of the lithium manganese iron phosphate-based particulate prepared in Comparative Example 2;

FIG. 7 is a graph plotting voltage versus capacity curves of three CR 2032 coin-type lithium batteries under a charge-discharge capacity test at a charge-discharge current of 0.1 C, each of the lithium batteries including a cathode made using a respective one of lithium manganese iron phosphate-based powdery materials prepared in Example 1, Comparative Example 1, and Comparative Example 2;

FIG. 8 is a graph plotting discharge capacity versus cycle number curves at discharge currents of 0.1 C, 1.0 C, 5.0 C, and 10.0 C of three CR 2032 coin-type lithium batteries under a discharge C-rate test at a charge current of 1.0 C, each of the lithium batteries including a cathode made using a respective one of the lithium manganese iron phosphate-based powdery materials prepared in Example 1, Comparative Example 1, and Comparative Example 2;

FIG. 9 is a graph plotting discharge capacity versus cycle number curves of three CR 2032 coin-type lithium batteries under a cycle life test at 55° C., each of the lithium batteries including a cathode made using a respective one of the lithium manganese iron phosphate-based powdery materials prepared in Example 1, Comparative Example 1, and Comparative Example 2; and

FIG. 10 is a graph plotting heat flow versus temperature curves of three CR 2032 coin-type lithium batteries under a thermal analysis (safety) test.

### DETAILED DESCRIPTION

The term “lithium battery” used in the specification of the disclosure includes a lithium primary battery and a lithium-ion secondary battery. A lithium manganese iron phosphate-based powdery material of the disclosure is useful for making a cathode of the lithium primary battery or the lithium-ion secondary battery. Specifically, the lithium manganese iron phosphate-based powdery material of the disclosure is useful for making the cathode of the lithium-ion secondary battery.

A lithium manganese iron phosphate-based particulate for a cathode of a lithium battery according to the disclosure includes a core portion and a shell portion. The core portion includes a plurality of first lithium manganese iron phosphate-based nanoparticles which are bound together and which have a first mean particle size. The shell portion encloses the core portion and includes a plurality of second lithium manganese iron phosphate-based nanoparticles which are bound together and which have a second mean particle size larger than the first mean particle size of the first lithium manganese iron phosphate-based nanoparticles of the core portion.

In certain embodiments, the first mean particle size of the first lithium manganese iron phosphate-based nanoparticles of the core portion of the lithium manganese iron phosphate-based particulate ranges from 30 nm to 150 nm so as to enhance an electron transfer rate and a mass transfer rate of a lithium manganese iron phosphate-based powdery material containing the lithium manganese iron phosphate-based particulates.

In certain embodiments, the second mean particle size of the second lithium manganese iron phosphate-based nanoparticles of the shell portion of the lithium manganese iron phosphate-based particulate ranges from 150 nm to 400 nm so as to further reduce a specific surface area of a lithium manganese iron phosphate-based powdery material containing the lithium manganese iron phosphate-based particulates.

In certain embodiments, the first lithium manganese iron phosphate-based nanoparticles of the core portion of the lithium manganese iron phosphate-based particulate is of a composition which is the same as that of the second lithium manganese iron phosphate-based nanoparticles of the shell portion of the lithium manganese iron phosphate-based particulate.

In certain embodiments, the composition of each of the first and second lithium manganese iron phosphate-based nanoparticles is represented by

LiₓMn_{1-y-z}Fe_{y}M_{z}PO₄,

wherein

0.9≤x≤1.2,

0.1≤y≤0.4,

0≤z≤0.1,

0.1≤y+z≤0.4, and

M is selected from the group consisting of Mg, Ca, Sr, Co, Ti, Zr, Ni, Cr, Zn, Al, and combinations thereof.

In certain embodiments, the first lithium manganese iron phosphate-based nanoparticles of the core portion of the lithium manganese iron phosphate-based particulate are bound together via sintering, and the second lithium manganese iron phosphate-based nanoparticles of the shell portion of the lithium manganese iron phosphate-based particulate are bound together via sintering.

A lithium manganese iron phosphate-based powdery material for a cathode of a lithium battery according to the disclosure includes a plurality of the lithium manganese iron phosphate-based particulates.

In certain embodiments, the lithium manganese iron phosphate-based particulates included in the lithium manganese iron phosphate-based powdery material have a mean particle size ranging from 0.6 to 20 μm.

In certain embodiments, the lithium manganese iron phosphate-based powdery material has a specific surface area ranging from 5 m²/g to 30 m²/g.

In certain embodiments, the lithium manganese iron phosphate-based powdery material has a tap density larger than 0.5 g/cm³.

A method for manufacturing the lithium manganese iron phosphate-based powdery material according to the disclosure comprises:

a) preparing a blend which includes a lithium source, a manganese source, an iron source, and a phosphorous source;

b) subjecting the blend to milling and pelletizing to form a pelletized mixture;

c) subjecting the pelletized mixture to a preliminary sintering treatment at a temperature ranging from 300° C. to 450° C. to form a pre-sintered preform;

d) subjecting the pre-sintered preform to an intermediate sintering treatment at a temperature ranging from 450° C. to 600° C. to form a mid-sintered preform; and

e) subjecting the mid-sintered preform to a final sintering treatment at a temperature ranging from 600° C. to 800° C. to form the lithium manganese iron phosphate-based powdery material.

In certain embodiments, the phosphorous source is water soluble. Examples of the phosphorous source include, but are not limited to, phosphoric acid, ammonium dihydrogen phosphate, sodium phosphate, and sodium dihydrogen phosphate, which may be used alone or in admixture of two or more. In certain embodiments, the lithium source is phosphoric acid.

In certain embodiments, examples of the manganese source includes, but are not limited to, manganese oxide, manganese oxalate, manganese carbonate, manganese sulfate, and manganese acetate, which may be used alone or in admixture of two or more. In certain embodiments, the manganese source is manganese oxide. The manganese source is used in an amount ranging from 0.6 mole to 0.9 mole based on 1 mole of the phosphorous source.

In certain embodiments, examples of the iron source include, but are not limited to, iron oxalate, iron oxide, iron, iron nitrate, and iron sulfate, which may be used alone or in admixture of two or more. In certain embodiments, the iron source is iron oxalate. The iron source is used in an amount ranging from 0.1 mole to 0.4 mole based on 1 mole of the phosphorous source.

In certain embodiments, examples of the lithium source include, but are not limited to, lithium carbonate, lithium hydroxide, lithium acetate, lithium nitrate, and lithium oxalate, which may be used alone or in admixture of two or more. In certain embodiments, the lithium source is lithium carbonate. The lithium source is used in an amount ranging from 0.9 mole to 1.2 moles based on 1 mole of the phosphorous source.

In certain embodiments, the blend further includes a source of an additional metal selected from the group consisting of Mg, Ca, Sr, Co, Ti, Zr, Ni, Cr, Zn, Al, and combinations thereof. The source of the additional metal is used to enhance a structural stability of the lithium manganese iron phosphate-based powdery material thus manufactured. In certain embodiments, the source of the additional metal is a magnesium source. The source of the additional metal is used in an amount ranging from 0.01 mole to 0.1 mole based on 1 mole of the phosphorous source.

In certain embodiments, the blend further includes a carbon source which is used as a reducing agent. Examples of the carbon source include, but are not limited to, glucose, citric acid, and Super P carbon black, which may be used alone or in admixture of two or more.

In certain embodiments, the blend may further include a solvent, if required. A non-limiting example of the solvent is water. There is no limit to the amount of the solvent. The amount of the solvent may be adjusted according to the amounts of the metal sources and the carbon source described above.

In certain embodiments, the blend is milled using, for example, a ball mill at a rotational speed ranging from 800 rpm to 2400 rpm for a period ranging from 1 hour to 5 hours. Thereafter, the blend is pelletized using a spray granulator at an inlet temperature ranging from 160° C. to 210° C.

It should be noted that the aforesaid manner for milling and pelletizing the blend is merely exemplary and should not be interpreted as a limit thereto.

In certain embodiments, the preliminary sintering treatment at a temperature ranging from 300° C. to 450° C. is performed for a period ranging from, for example, 6 hours to 12 hours.

In certain embodiments, the intermediate sintering treatment at a temperature ranging from 450° C. to 600° C. is performed for a period ranging from, for example, 2 hours to 6 hours.

In certain embodiments, the final sintering treatment at a temperature ranging from 600° C. to 800° C. is performed for a period ranging from, for example, 2 hours to 6 hours.

Examples of the disclosure will be described hereinafter. It is to be understood that these examples are exemplary and explanatory and should not be construed as a limitation to the disclosure.

### EXAMPLE 1

Manganese oxide, iron oxalate, magnesium oxide, and phosphoric acid were blended at a molar ratio of 0.8:0.15:0.05:1.0 in a proper amount of water at a temperature above 30° C. for 1 hour, followed by blending with lithium carbonate in a molar ratio of lithium carbonate to phosphoric acid of 1.02 to 1.00 and then blending with a proper amount of glucose to obtain a blend. The blend was milled in a ball mill for 4 hours to obtain a milled blend. The milled blend was pelletized using a spray granulator at an inlet temperature of 200° C. to obtain a pelletized mixture. The pelletized mixture was subjected to a preliminary sintering treatment in a bell type furnace under a nitrogen atmosphere at 450° C. for 10 hours to form a pre-sintered preform. The pre-sintered preform was subjected to an intermediate sintering treatment in the bell type furnace at 600° C. for 2 hours to form a mid-sintered preform. The mid-sintered preform was subjected to a final sintering treatment in the bell type furnace at 750° C. for 3 hours, followed by cooling to room temperature (25° C.) to form a lithium manganese iron phosphate-based powdery material having a specific surface area of 18.1 m²/g and a tap density of 1.21 g/cm³.

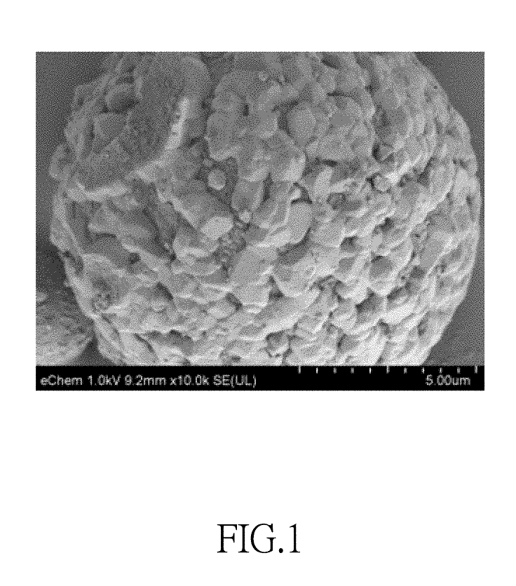

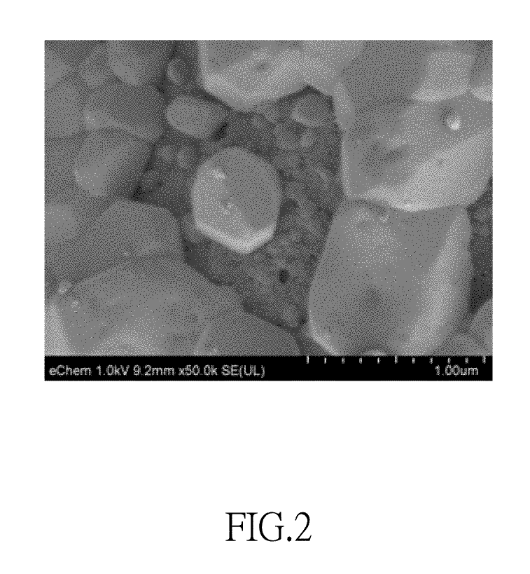

The lithium manganese iron phosphate-based powdery material thus formed was observed using a scanning electron microscope (Hitachi SU8000), and images as shown in FIGS. 1 and 2 were obtained. As shown in FIGS. 1 and 2, the lithium manganese iron phosphate-based particulate contained in the lithium manganese iron phosphate-based powdery material includes a core portion, which was formed by sintering a plurality of lithium manganese iron phosphate-based nanoparticles having a mean particle size of 50 nm together, and a shell portion, which was formed by sintering a plurality of lithium manganese iron phosphate-based nanoparticles having a mean particle size of 400 nm together. The compositions of the first and second lithium manganese iron phosphate-based nanoparticles were analyzed using a Perkin Elmer Optima 7000DV system to be Li_{1.02}Mn_{0.8}Fe_{0.15}Mg_{0.05}PO₄.

### Comparative Example 1

Manganese oxide, iron oxalate, magnesium oxide, and phosphoric acid were blended at a molar ratio of 0.8:0.15:0.05:1.0 in a proper amount of water at a temperature above 30° C. for 1 hour, followed by blending with lithium carbonate in a molar ratio of lithium carbonate to phosphoric acid of 1.02 to 1.00 and then blending with a proper amount of glucose to obtain a blend. The blend was milled in a ball mill for 3 hours to obtain a milled blend. The milled blend was pelletized using a spray granulator at an inlet temperature of 200° C. to obtain a pelletized mixture. The pelletized mixture was subjected to a preliminary sintering treatment in a bell type furnace under a nitrogen atmosphere at 450° C. for 8 hours to form a pre-sintered preform. The pre-sintered preform was subjected to a final sintering treatment in the bell type furnace at 650° C. for 6 hours, followed by cooling to room temperature (25° C.) to form a lithium manganese iron phosphate-based powdery material having a specific surface area of 26.3 m²/g and a tap density of 1.12 g/cm³.

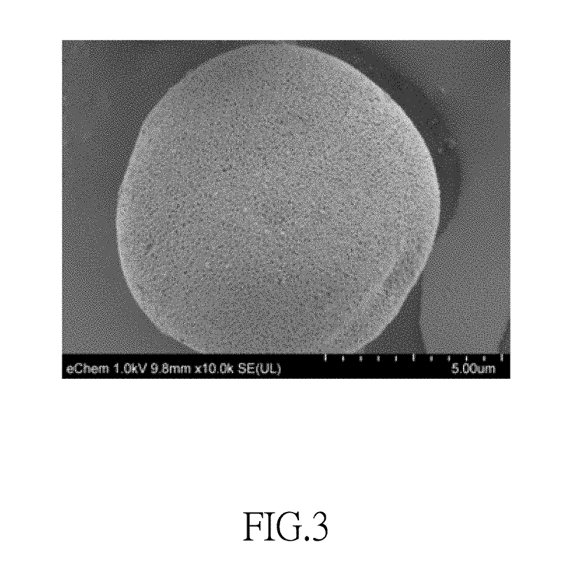

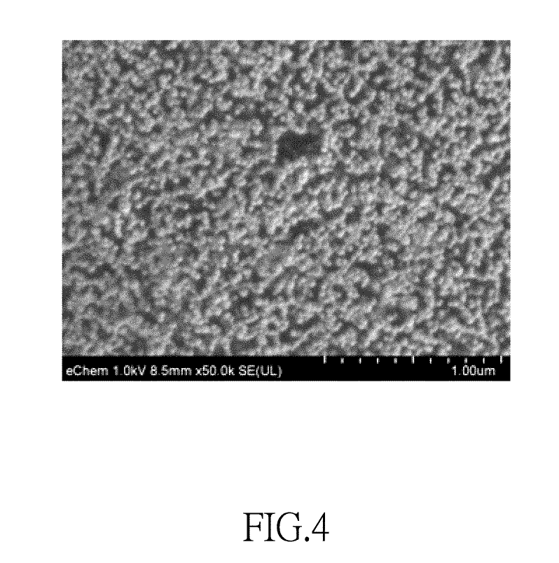

The lithium manganese iron phosphate-based powdery material thus formed was observed using a scanning electron microscope (Hitachi SU8000), and images as shown in FIGS. 3 and 4 were obtained. As shown in FIGS. 3 and 4, the lithium manganese iron phosphate-based particulate contained in the lithium manganese iron phosphate-based powdery material is formed by sintering a plurality of lithium manganese iron phosphate-based nanoparticles having a mean particle size of 70 nm together and did not have a core-shell configuration. The compositions of the lithium manganese iron phosphate-based nanoparticles were analyzed using a Perkin Elmer Optima 7000DV system to be Li_{1.02}Mn_{0.8}Fe_{0.15}Mg_{0.05}PO₄.

### Comparative Example 2

Manganese oxide, iron oxalate, magnesium oxide, and phosphoric acid were blended at a molar ratio of 0.8:0.15:0.05:1.0 in a proper amount of water at a temperature above 30° C. for 1 hour, followed by blending with lithium carbonate in a molar ratio of lithium carbonate to phosphoric acid of 1.02 to 1.00 and then blending with a proper amount of glucose to obtain a blend. The blend was milled in a ball mill for 2 hours to obtain a milled blend. The milled blend was pelletized using a spray granulator at an inlet temperature of 200° C. to obtain a pelletized mixture. The pelletized mixture was subjected to a preliminary sintering treatment in a bell type furnace under a nitrogen atmosphere at 450° C. for 8 hours to form a pre-sintered preform. The pre-sintered preform was subjected to a final sintering treatment in the bell type furnace at 750° C. for 6 hours, followed by cooling to room temperature (25° C.) to form a lithium manganese iron phosphate-based powdery material having a specific surface area of 14.2 m²/g and a tap density of 1.15 g/cm³.

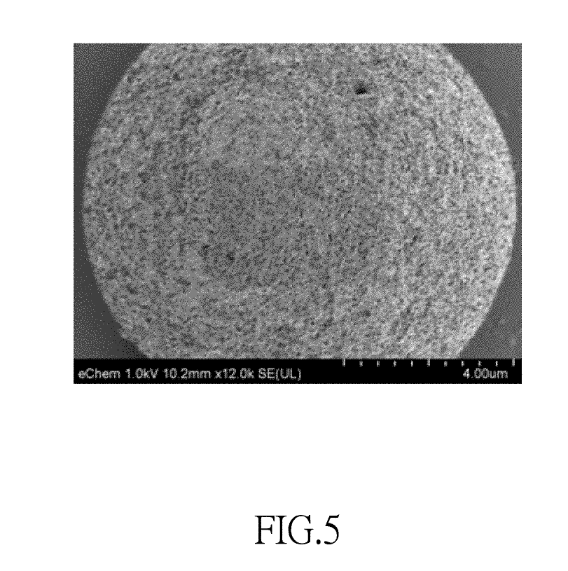

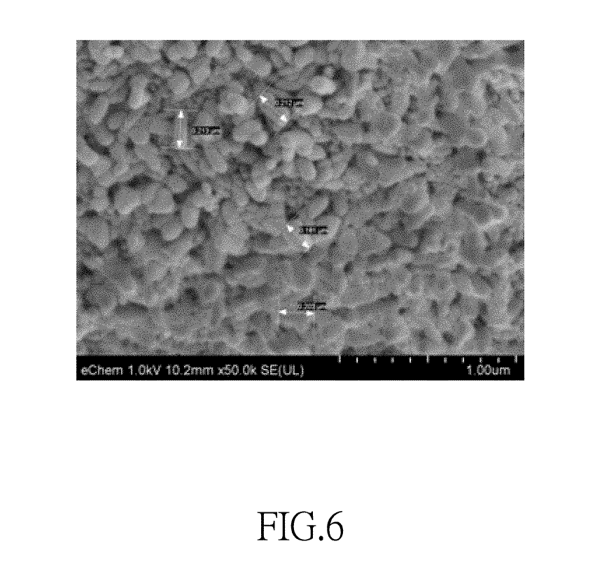

The lithium manganese iron phosphate-based powdery material thus formed was observed using a scanning electron microscope (Hitachi SU8000), and images as shown in FIGS. 5 and 6 were obtained. As shown in FIGS. 5 and 6, the lithium manganese iron phosphate-based particulate contained in the lithium manganese iron phosphate-based powdery material is formed by sintering a plurality of lithium manganese iron phosphate-based nanoparticles having a mean particle size of 250 nm together and did not have a core-shell configuration. The compositions of the lithium manganese iron phosphate-based nanoparticles were analyzed using a Perkin Elmer Optima 7000DV system to be Li_{1.02}Mn_{0.8}Fe_{0.15}Mg_{0.05}PO₄.

### Property Evaluation:

The lithium manganese iron phosphate-based powdery material prepared in each of Example 1, Comparative Example 1, and Comparative Example 2 was used to manufacture a CR 2032 coin-type lithium battery according to the following procedures.

The lithium manganese iron phosphate-based powdery material, a combination of graphite and carbon black, and polyvinylidene fluoride were blended at a weight ratio of 93:3:4 to obtain a blend. The blend was mixed with N-methyl-2-pyrrolidone (6 g) to obtain a paste. The paste was applied onto an aluminum foil having a thickness of 20 μm, followed by a preliminary baking on a heating platform and a further baking in vacuum to remove N-methyl-2-pyrrolidone to thereby obtain a cathode material. The cathode material was pressed and cut into a coin-type cathode with a diameter of 12 mm.

A lithium metal was used to make an anode with a thickness of 0.3 mm and a diameter of 1.5 cm.

Lithium hexafluorophosphate (LiPF₆, 1M) was dissolved in a solvent system composed of ethylene carbonate, ethylmethyl carbonate, and dimethyl carbonate in a volume ratio of 1:1:1 to obtain an electrolytic solution.

The cathode, the anode, and the electrolytic solution thus prepared were used to manufacture a CR 2032 coin-type lithium battery.

Each of the CR 2032 coin-type lithium batteries thus manufactured was analyzed by the following evaluation methods.

### 1. Charge-Discharge Capacity Test:

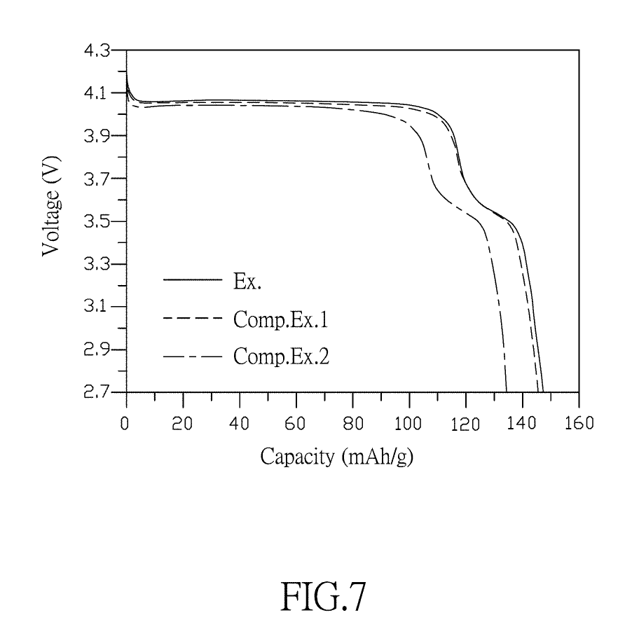

Discharge capacity of each of the CR 2032 coin-type lithium batteries was measured at a current level of 0.1 C and at a voltage ranging from 2.7 V to 4.25 V. The results are shown in FIG. 7.

### 2. Discharge C-Rate Test:

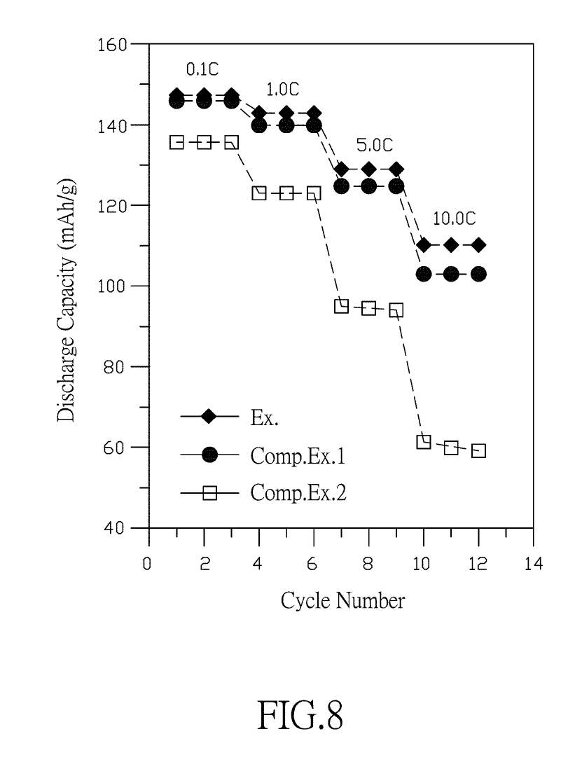

Initial discharge capacities at discharge currents of 0.1 C, 1.0 C, 5.0 C, and 10.0 C of each of the CR 2032 coin-type lithium batteries was measured at a charge current of 1.0 C and at a voltage ranging from 2.7 V to 4.25 V. The results are shown in FIG. 8.

### 3. Cycle Life Test:

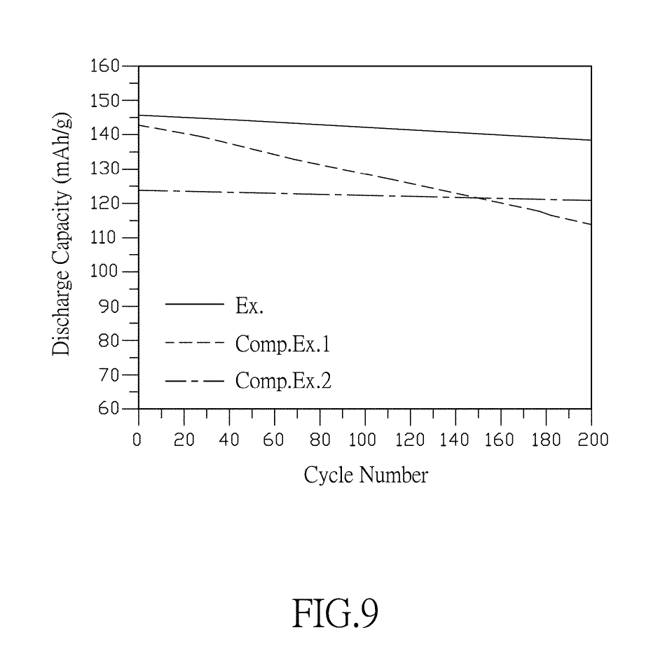

Each of the CR 2032 coin-type lithium batteries was measured at 55° C., a constant current of 2.0 C, a voltage ranging from 2.7 V to 4.25 V, and a period of 200 charge-discharge cycles. The results are shown in FIG. 9.

### 4. Thermal Analysis (Safety) Test:

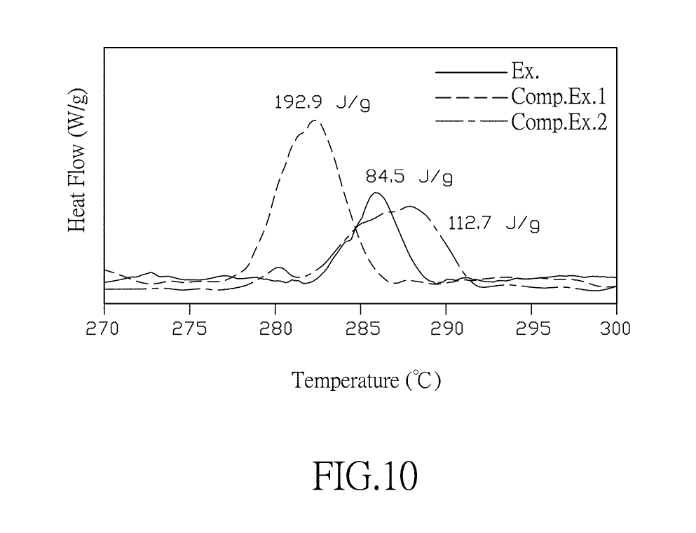

Each of the CR 2032 coin-type lithium batteries was disassembled after it was charged to a voltage of 4.25 V to obtain the cathode therein. The lithium manganese iron phosphate-based powdery material was scraped from the cathode. 3 mg of the lithium manganese iron phosphate-based powdery material was put into an aluminum crucible. Thereafter, the aluminum crucible was added with the electrolytic solution (3 μm) and sealed. A thermal analysis was performed using a differential scanning calorimeter (Perkin Elmer DSC7) at a heating rate of 5° C./min and a scanning temperature ranging from 200° C. to 350° C. The results are shown in FIG. 10. A 5% weight loss temperature was recorded as a thermal decomposition temperature (Td).

As shown in FIG. 7, the CR 2032 coin-type lithium battery manufactured using the lithium manganese iron phosphate-based powdery material prepared in Example 1 has a discharge capacity of 146.7 mAh/g. The CR 2032 coin-type lithium battery manufactured using the lithium manganese iron phosphate-based powdery material prepared in Comparative Example 1 has a discharge capacity of 144.2 mAh/g, and the CR 2032 coin-type lithium battery manufactured using the lithium manganese iron phosphate-based powdery material prepared in Comparative Example 2 has a discharge capacity of 132.8 mAh/g.

As shown in FIG. 8, the discharge capacities at discharge currents of 0.1 C, 1.0 C, 5.0 C, and 10.0 C of the CR 2032 coin-type lithium battery manufactured using the lithium manganese iron phosphate-based powdery material prepared in Example 1 are relatively high compared to those of the CR 2032 coin-type lithium batteries manufactured using the lithium manganese iron phosphate-based powdery materials prepared in Comparative Examples 1 and 2. Furthermore, in the CR 2032 coin-type lithium battery manufactured using the lithium manganese iron phosphate-based powdery material prepared in Example 1, the capacity at the discharge current of 10 C was 75% of that at the discharge current of 0.1 C. In the CR 2032 coin-type lithium batteries manufactured using the lithium manganese iron phosphate-based powdery materials prepared in Comparative Examples 1 and 2, the capacities at the discharge current of 10 C were respectively 68% and 47% of those at the discharge current of 0.1 C.

As shown in FIG. 9, the capacity of the CR 2032 coin-type lithium battery manufactured using the lithium manganese iron phosphate-based powdery material prepared in Example 1 after 200 charge-discharge cycles is 97% of an initial capacity thereof. The capacity of the CR 2032 coin-type lithium battery manufactured using the lithium manganese iron phosphate-based powdery material prepared in Comparative Example 1 after 200 charge-discharge cycles is 82% of an initial capacity thereof. The capacity of the CR 2032 coin-type lithium battery manufactured using the lithium manganese iron phosphate-based powdery material prepared in Comparative Example 2 after 200 charge-discharge cycles is 98% of an initial capacity thereof.

As shown in Table 10, after each of the CR 2032 coin-type lithium batteries was charged to a voltage of 4.25 V, the amounts of heat released from the lithium manganese iron phosphate-based powdery materials prepared in Example 1, Comparative Example 1, and Comparative Example 2 are 84.5 J/g, 192.9 J/g, and 112.7 J/g, respectively. In addition, the thermal decomposition temperature (Td) of the lithium manganese iron phosphate-based powdery material prepared in Example 1 was measured to be 286.1° C.

In view of the aforesaid, the lithium manganese iron phosphate-based powdery material according to the disclosure, which includes the lithium manganese iron phosphate-based particulates each of which is formed with a specific core-shell configuration, may be used to manufacture a lithium battery having a high energy density, a good thermal stability, and a superior charge-discharge cycling stability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A lithium manganese iron phosphate-based particulate for a cathode of a lithium battery, comprising:
a core portion including a plurality of first lithium manganese iron phosphate-based nanoparticles which are bound together and which have a first mean particle size; and
a shell portion enclosing said core portion and including a plurality of second lithium manganese iron phosphate-based nanoparticles which are bound together and which have a second mean particle size larger than the first mean particle size of said first lithium manganese iron phosphate-based nanoparticles of said core portion.

2. The lithium manganese iron phosphate-based particulate according to claim 1, wherein the first mean particle size of said first lithium manganese iron phosphate-based nanoparticles of said core portion ranges from 30 nm to 150 nm.

3. The lithium manganese iron phosphate-based particulate according to claim 1, wherein the second mean particle size of said second lithium manganese iron phosphate-based nanoparticles of said shell portion ranges from 150 nm to 400 nm.

4. The lithium manganese iron phosphate-based particulate according to claim 1, wherein said first lithium manganese iron phosphate-based nanoparticles of said core portion is of a composition which is the same as that of said second lithium manganese iron phosphate-based nanoparticles of said shell portion.

5. The lithium manganese iron phosphate-based particulate according to claim 4, wherein the composition of each of said first and second lithium manganese iron phosphate-based nanoparticles is represented by
LiₓMn_{1-y-z}Fe_{y}M_{z}PO₄,
wherein
0.9≤x≤1.2,
0.1≤y≤0.4,
0≤z≤0.1,
0.1≤y+z≤0.4, and
M is selected from the group consisting of Mg, Ca, Sr, Co, Ti, Zr, Ni, Cr, Zn, Al, and combinations thereof.

6. The lithium manganese iron phosphate-based particulate according to claim 1, wherein said first lithium manganese iron phosphate-based nanoparticles of said core portion are bound together via sintering, and said second lithium manganese iron phosphate-based nanoparticles of said shell portion are bound together via sintering.

7. A lithium manganese iron phosphate-based powdery material for a cathode of a lithium battery, comprising a plurality of lithium manganese iron phosphate-based particulates each according to claim 1.

8. The lithium manganese iron phosphate-based powdery material according to claim 7, wherein said lithium manganese iron phosphate-based particulates have a mean particle size ranging from 0.6 to 20 μm.

9. The lithium manganese iron phosphate-based powdery material according to claim 7, having a specific surface area ranging from 5 m²/g to 30 m²/g.

10. The lithium manganese iron phosphate-based powdery material according to claim 7, having a tap density larger than 0.5 g/cm³.

11. A method for manufacturing a lithium manganese iron phosphate-based powdery material for a cathode of a lithium battery, comprising:
a) preparing a blend which includes a lithium source, a manganese source, an iron source, and a phosphorous source;
b) subjecting the blend to milling and pelletizing to form a pelletized mixture;
c) subjecting the pelletized mixture to a preliminary sintering treatment at a temperature ranging from 300° C. to 450° C. to form a pre-sintered preform;
d) subjecting the pre-sintered preform to an intermediate sintering treatment at a temperature ranging from 450° C. to 600° C. to form a mid-sintered preform; and
e) subjecting the mid-sintered preform to a final sintering treatment at a temperature ranging from 600° C. to 800° C. to form the lithium manganese iron phosphate-based powdery material.

12. The method according to claim 11, wherein the blend further includes a source of an additional metal selected from the group consisting of Mg, Ca, Sr, Co, Ti, Zr, Ni, Cr, Zn, Al, and combinations thereof.
